(19) United States
(12) Patent Application Publication
(10) Pub. No.: US 2017/0176204 A1
(43) Pub. Date: Jun. 22, 2017

(54) VEHICLE NAVIGATION SYSTEM WITH CUSTOMIZABLE SEARCHING SCOPE

(71) Applicant: JAGUAR LAND ROVER LIMITED, Warwickshire (GB)

(72) Inventors: Matt Jones, Portland, OR (US); Paul Wheller, Portland, OR (US); Peter Bontrager, Portland, OR (US)

(21) Appl. No.: 14/972,753

(22) Filed: Dec. 17, 2015

(51) Int. Cl. G01C 21/36; B60K 35/00

(52) U.S. Cl. CPC G01C 21/36; B60K 35/00; B60K 2350/1004; B60K 2350/1052

(57) ABSTRACT

An illustrative example vehicle navigation system includes a controller and a user interface. The user interface receives user input regarding at least one criterion of interest to the user and a desired area within which to identify a location satisfying the at least one criterion. The user interface provides an indication of the user input to the controller. The controller determines a current position and direction of a vehicle associated with the system. The controller identifies a place of potential interest as any location that satisfies the at least one criterion and is within the desired area relative to the current position of the vehicle. The controller causes the user interface to provide an output at least on a display screen. The output includes an indication of the desired area and any identified place of potential interest.

### TECHNICAL FIELD

The present disclosure relates to providing information to assist a driver to find locations of interest while driving. Aspects of the invention relate to a system, a vehicle and a method.

### BACKGROUND

With advances in computing technology, it has become increasingly possible to incorporate information and entertainment devices on vehicles. Navigation systems are one example that rely upon computing technology for providing automated route guidance to a driver. Such systems have proven useful and have gained widespread acceptance. Some such systems provide the ability for an individual to search for locations based on a category, for example. User experience with such systems can be less than satisfactory because of the limitations on how the user may make a request and the way in which information is provided to the user. Additionally, the amount of user involvement required for making such a request can make it challenging except when the vehicle is stationary and the individual is not actively driving the vehicle.

It would be beneficial to be able to provide additional information through a vehicle navigation system in a way that meets an individual's desires or needs in a more convenient and effective manner.

### SUMMARY OF THE INVENTION

Aspects and embodiments of the invention provide a system, a method and a vehicle as claimed in the appended claims;

According to an aspect of the invention, there is provided a vehicle navigation system, comprising a control means and a user interface means. The user interface receives user input regarding at least one criterion of interest to the user and a desired area within which to identify a location satisfying the at least one criterion The user interface provides an indication of the user input to the controller. The controller determines a current position and direction of a vehicle associated with the system. The controller identifies a place of potential interest as any location that satisfies the at least one criterion and is within the desired area relative to the current position of the vehicle. The controller causes the user interface to provide an output at least on the display screen, the output including an indication of the desired area and any identified place of potential interest.

In an example embodiment having one or more features of the system of the previous paragraph, the control means comprises at least a processor and memory associated with the processor and the user interface means includes at least a display screen.

In an example embodiment having one or more features of the system of either of the previous paragraphs, the output includes an indication of the current position of the vehicle and an indication of a position of any identified place of potential interest relative to the current position of the vehicle.

In an example embodiment having one or more features of the system of any of the previous paragraphs, the control means controls the user interface means to include an indication of the current position of the vehicle with the output and the control means controls the user interface means to provide an indication of a customized arrangement of the desired area relative to the current position of the vehicle.

In an example embodiment having one or more features of the system of any of the previous paragraphs, the control means dynamically updates a position of the desired area based on changes in the current position of the vehicle and dynamically identifies any places of potential interest based on the updated desired area.

In an example embodiment having one or more features of the system of any of the previous paragraphs, the user interface means comprises a touch screen and the user interface means receives the user input based on user interaction with the touch screen.

In an example embodiment having one or more features of the system of any of the previous paragraphs, the control means interprets a user gesture near the touch screen as an indication of the desired area.

In an example embodiment having one or more features of the system of any of the previous paragraphs, the user gesture comprises at least one of movement of at least two fingers closer together to indicate a desire to reduce a size of the desired area, movement of at least two fingers further apart to indicate a desire to increase a size of the desired area and movement of at least one finger relative to the current position of the vehicle to indicate a desire to adjust an arrangement of the desired area relative to the current position of the vehicle.

In an example embodiment having one or more features of the system of any of the previous paragraphs, the user interface means receives user input indicating a desire for more information regarding a selected one of the places of potential interest and the control means causes the user interface means to provide additional information regarding the selected one of the places.

In an example embodiment having one or more features of the system of any of the previous paragraphs, the additional information comprises at least one of an indication of a travel distance to the selected one of the places from the current location of the vehicle, and an indication of a travel time to the selected one of the places from the current location of the vehicle.

In an example embodiment having one or more features of the system of any of the previous paragraphs, the desired area is defined by at least one of a geographic distance from the current position of the vehicle, a travel distance from the current position of the vehicle and a travel time from the current position of the vehicle.

According to another aspect of the invention, there is provided a vehicle comprising the system of any of the previous paragraphs.

According to another aspect of the invention, there is provided a method of providing information to a driver of a vehicle through a vehicle navigation system user interface that includes at least a display screen. The method comprises receiving user input regarding at least one criterion of interest to the user and a desired area within which to identify a location satisfying the at least one criterion, determining a current position and direction of travel of the vehicle, identifying a place of potential interest as any location that satisfies the at least one criterion and is within the desired area relative to the current position of the vehicle and provide an output at least on the display screen, the output including an indication of the desired area and any identified place of potential interest.

In an example embodiment having one or more features of the method of the previous paragraph, the output includes an indication of the current position of the vehicle and an indication of a position of any identified place of potential interest relative to the current position of the vehicle.

In an example embodiment having one or more features of the method of either of the previous paragraphs, the method includes providing an indication of the current position of the vehicle on the display screen and receiving user input customizing an arrangement of the desired area relative to the current position of the vehicle.

In an example embodiment having one or more features of the method of any of the previous paragraphs, the method includes dynamically updating a position of the desired area based on changes in the current position of the vehicle and dynamically identifying any places of potential interest based on the updated desired area.

In an example embodiment having one or more features of the method of any of the previous paragraphs, the display screen comprises a touch screen and receiving the user input is based on user interaction with the touch screen.

In an example embodiment having one or more features of the method of any of the previous paragraphs, the method includes interpreting a user gesture near the touch screen as an indication of the desired area.

In an example embodiment having one or more features of the method of any of the previous paragraphs, the user gesture comprises at least one of movement of at least two fingers closer together to indicate a desire to reduce a size of the desired area, movement of at least two fingers further apart to indicate a desire to increase a size of the desired area and movement of at least one finger relative to the current position of the vehicle to indicate a desire to adjust an arrangement of the desired area relative to the current position of the vehicle.

In an example embodiment having one or more features of the method of any of the previous paragraphs, the method includes receiving user input indicating a desire for more information regarding a selected one of the places of potential interest and providing additional information regarding the selected one of the places on the display screen.

In an example embodiment having one or more features of the method of any of the previous paragraphs, the additional information comprises at least one of an indication of a travel distance to the selected one of the places from the current location of the vehicle and an indication of a travel time to the selected one of the places from the current location of the vehicle.

In an example embodiment having one or more features of the method of any of the previous paragraphs, the desired area is defined by at least one of a geographic distance from the current position of the vehicle, a travel distance from the current position of the vehicle and a travel time from the current position of the vehicle.

According to another aspect of the invention there is provided a vehicle comprising a controller and the display screen configured to perform the method of any of the previous paragraphs.

According to another aspect of the invention, there is provided a vehicle navigation system, comprising a controller including at least a processor and memory associated with the processor and a user interface that is controlled by the controller, the user interface including at least a display screen. The user interface receives user input regarding at least one criterion of interest to the user and a desired area within which to identify a location satisfying the at least one criterion The user interface provides an indication of the user input to the controller. The controller determines a current position and direction of a vehicle associated with the system. The controller identifies a place of potential interest as any location that satisfies the at least one criterion and is within the desired area relative to the current position of the vehicle. The controller causes the user interface to provide an output at least on the display screen, the output including an indication of the desired area and any identified place of potential interest.

Within the scope of this document it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 diagrammatically illustrates an example embodiment of a system designed according to an embodiment of this invention associated with a vehicle;

FIG. 2 schematically illustrates selected portions of the example system of FIG. 1;

FIG. 3 is a flowchart diagram summarizing an example approach; and

FIGS. 4A and 4B diagrammatically illustrate an example type of user output provided according to an embodiment of this invention.

### DETAILED DESCRIPTION

Embodiments of this invention provide information to an individual within a vehicle to assist that individual in locating places of potential interest in a customizable manner.

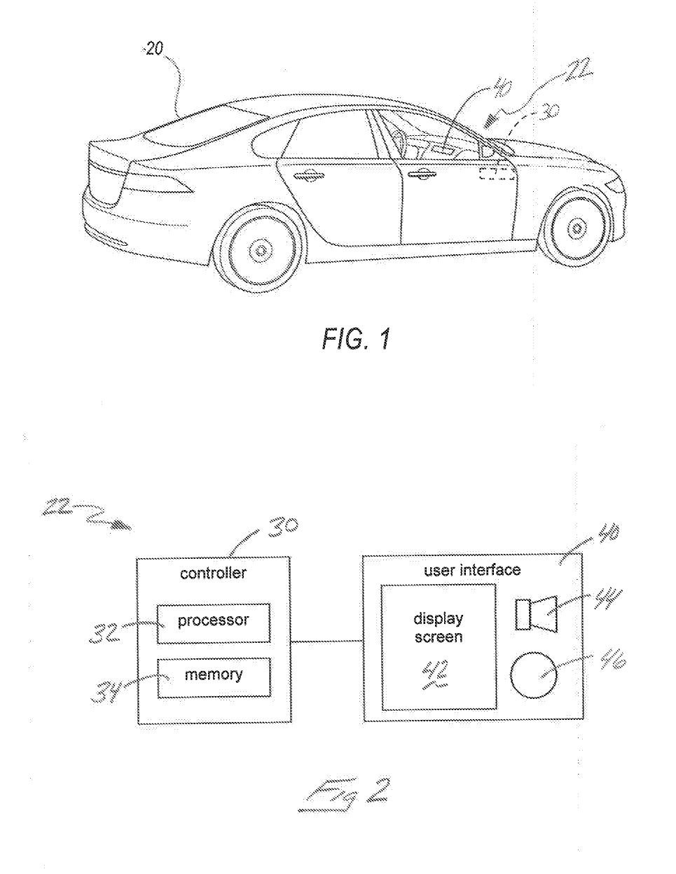

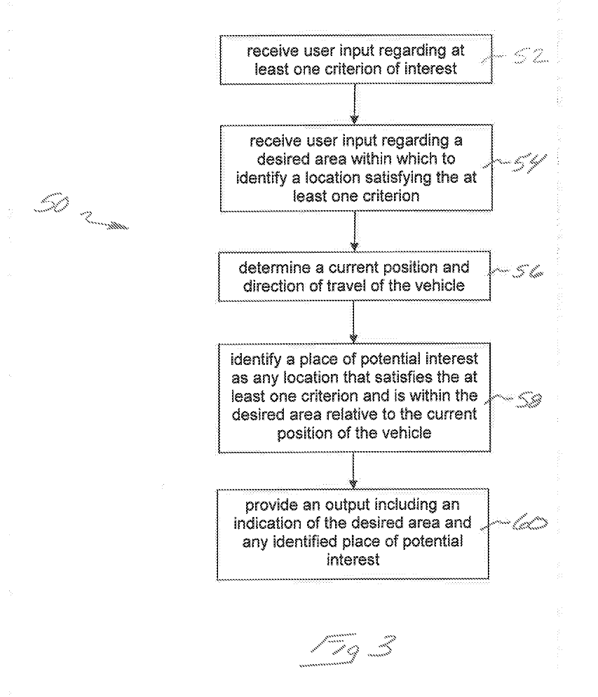

Referring to FIGS. 1 and 2, a vehicle 20 has an associated navigation system 22. A control means 30 includes at least one computing device 32, such as an electronic controller or a processor, and memory 34 associated with the computing device. The computing device 32 is a navigation system controller particularly configured to perform functions and automate determinations associated with a vehicle navigation system. The control means 30 is capable of processing navigation information using known techniques.

For discussion purposes, the control means 30 may be referred to as a controller in the following description.

The computing device 32 can comprise a control unit or computational device having one or more electronic processors (e.g., a microprocessor, a microcontroller, an application specific integrated circuit (ASIC), etc.), and may comprise a single device or multiple devices that collectively operate as the computing device 32. The term “controller,” “control unit,” or “computational device” may include a single controller, control unit, or computational device, and a plurality of controllers, control units, or computational devices collectively operating to provide the required control functionality.

A set of instructions is provided in the memory 34 in some embodiments which, when executed, cause the controller 30 to implement the control techniques mentioned in this description (including some or all of the functionality required for the described method). The set of instructions could be embedded in one or more electronic processors of the computing device 32; or alternatively, the set of instructions could be provided as software to be executed in the computing device 32. Given this description those skilled in the art will realize what type of hardware, software, firmware, or a combination of these will best suit their particular needs.

The memory 34 may include information useful for navigation determinations in addition to the instructions mentioned above. The memory 34 may be on board the vehicle 20, a remotely accessible data storage, or a combination of on board and remote memory. Although the computing device 32 and the memory 34 are schematically shown separately in the drawing, that is primarily for discussion purposes. The computing device 32 and the memory 34 may be integrated into a single device or component. Additionally, they may be a portion of a controller that is used for other purposes, such as a vehicle engine control unit.

A user interface means 40 includes at least a display screen 42 that provides a visual output to an individual within the vehicle 20. An audio output or speaker 44 is provided in the illustrated example to provide audible indications regarding information of use or interest to an individual within the vehicle 20. The example user interface means 40 includes an input mechanism 46, such as a keypad, dial, switch, or pointer device, to facilitate the user providing input to the system 22.

According to an example embodiment, the display screen 42 is a touch screen that is configured to detect a user gesture near the screen utilizing known close proximity or contact sensing techniques. In this example, the display screen 42 serves as an output and input device of the user interface means 40.

FIG. 3 is a flowchart diagram 50 summarizing an example method of providing information to an individual in the vehicle 20 through the navigation system 22. At 52, the system 22 receives user input through the user interface 40 regarding at least one criterion of interest to the user. The user input may specify particular types of business establishments, for example, that the individual would like to know about while driving the vehicle 20.

At 54, the user provides input regarding a desired area within which to identify a location satisfying the at least one criterion. The desired area may be defined in terms of a geographic distance, such as a search radius or range from a current position or a predetermined route of the vehicle 20. The desired area may also be defined in terms of a maximum acceptable or desirable travel distance, which takes into account information regarding a potential route from a current vehicle location or an upcoming location along a route of the vehicle to the location of a place of interest based on the criterion established by the user. A geographic distance and a travel distance may be different or the same depending on the configuration of road surfaces available to an individual for traveling from a current vehicle position to the position of a place of interest. The illustrated example embodiment allows a user to customize the size of the desired area based on geographic distance or travel distance.

Another way in which the desired area may be defined in this example embodiment is by travel time between a current vehicle location and the location of a place of interest that satisfies the at least one criterion input by the user. In some instances, an individual may not be concerned with the actual distance as much as being concerned with how long it will take to travel from a current vehicle position, which may be along a desired route to an intended destination, and a point of interest identified by the system 22. For example, a driver may not wish to deviate from a current route for more than ten minutes. The illustrated example allows an individual to set the range or limit on the desired area based upon travel time.

Some embodiments use a combination of time and distance information to set or determine the size, scope or range of the desired area.

At 56, the controller 30 determines a current position and direction of travel of the vehicle 20. In one example, the controller 30 utilizes known global positioning and navigation techniques for making the determinations at 56.

At 58, the controller 30 identifies any location that satisfies the at least one criterion and is within the desired area as a place of potential interest. At 60, the controller 30 causes the user interface 40 to provide an output at least on the display screen 42 indicating the desired area and any identified place of potential interest within the desired area.

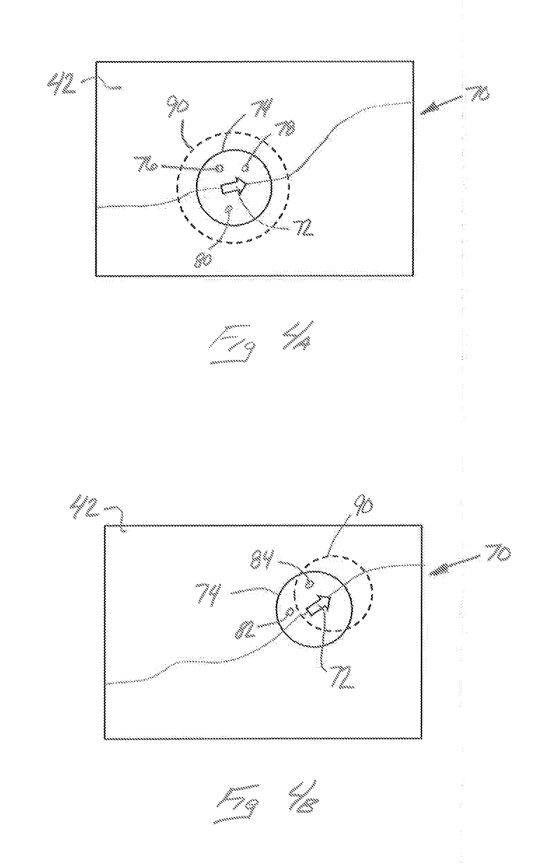

As shown in FIG. 4A, an example display output 70 includes an indication of the current position of the vehicle at 72. The desired area is shown at 74. In the illustrated example, the desired area 74 is represented by a circle that surrounds the current position of the vehicle 72. The actual configuration of the desired area may be different than a circle when the desired area is defined in terms of actual travel distance or travel time. For simplicity and aesthetic reasons, the desired area 74 may be represented as a circle for informing the user of the approximate range of the desired area. Other shapes are useful in some embodiments.

The output 70 includes indications of several places of potential interest shown at 76, 78 and 80. The symbol or indication of the identified places of potential interest may have a variety of shapes or colors depending on the particular type of establishment, for example.

Comparing FIG. 4B to FIG. 4A, the current position of the vehicle 72 is different in FIG. 4B. The controller 30 continuously and dynamically updates the desired area 74 based upon the current position of the vehicle 72. Accordingly, the display shown in FIG. 4B includes the desired area 74 repositioned relative to the position of the desired area in FIG. 4A. Additionally, the controller 30 continuously and dynamically updates determinations regarding potential places of interest. Two identified places of interest 82 and 84 are schematically shown in FIG. 4B, which were not within the desired area when the vehicle is at the location 72 shown in FIG. 4A but are with the desired area 74 relative to the current location of the vehicle 72 in FIG. 4B.

One feature of the illustrated example embodiment is that it allows for the user to customize the desired area within which to find places of potential interest. Considering FIG. 4A, the user may expand or contract the desired area 74 by providing input through the user interface 40. In an embodiment that includes a touch screen as the display screen 42, the user may perform a gesture with at least two fingers on or near the display screen 42. Assuming the user spreads two fingers apart close to or on the position of the desired area 74 on the display screen 42, the controller receives such input and interprets it as a desire to expand the desired area to a range as schematically shown at 90. Similarly, if a user were to bring two fingers closer together while touching or near the position of the desired area on the screen 42, the controller 30 will reduce the size, scope or range of the desired area.

FIG. 4B schematically shows another way in which the desired area may be customized to have a particular arrangement relative to the current position of the vehicle. In FIG. 4B, the user performs a gesture involving at least one finger to move the desired area relative to the current position of the vehicle 72. For example, consider an individual being more interested in places of potential interest the vehicle is approaching compared to places of potential interest that have recently been passed. An example user input to indicate a preference to arrange the desired area more forward of the vehicle may include placing one finger within close proximity to the current position of the vehicle 72 and using the other finger to move the desired area relative to that current position. The controller 30 interprets such input received through the touch screen 42 as an indication to move the desired area from the position shown at 74 to the position shown at 90 in FIG. 4B.

A user may also customize the arrangement of the desired area relative to the current position of the vehicle utilizing other types of input to achieve other types of results. For example, the shape of the desired area may be changed.

Additionally, more information or other formats of information may be provided through the user interface 40. The example of FIGS. 4A and 4B is one example embodiment of an output that includes an indication of a desired area and any identified place of potential interest.

In the illustrated embodiment, an individual may select one of the indicated places of potential interest to provide user input indicating a desire for more information regarding the selected place. The controller 30 interprets such input and causes the user interface 40 to provide additional information regarding the selected place as such information is available or determined by the controller 30. Example types of additional information include an indication of a travel distance to the selected place from the current location of the vehicle. Another example type of further information includes an indication of a travel time to the selected place from the current location of the vehicle. The indication of travel distance or travel time to a selected placed in the illustrated embodiment is dynamically updated for a predetermined amount of time until the user selects a different place, indicates no further interest in that place, or the selected place ceases to be within the desired area based upon movement of the vehicle.

The preceding description is illustrative rather than limiting in nature. Variations and modifications to the disclosed examples may become apparent to those skilled in the art that do not necessarily depart from the essence of the contribution to the art provided by the disclosed embodiments. The scope of legal protection can only be determined by studying the following claims.

We claim:

1. A vehicle navigation system, comprising:
user interface means for receiving user input and providing an output; and
control means for controlling the user interface means based user input,
wherein:
the user interface means receives user input regarding at least one criterion of interest to the user and a desired area within which to identify a location satisfying the at least one criterion,
the user interface means provides an indication of the user input to the control means,
the control means determines a current position and direction of a vehicle associated with the system,
the control means identifies a place of potential interest as any location that satisfies the at least one criterion and is within the desired area relative to the current position of the vehicle, and
the control means causes the user interface means to provide an output at least on a display screen of the user interface means, the output including an indication of the desired area and any identified place of potential interest.

2. The system of claim 1, wherein the output includes an indication of the current position of the vehicle and an indication of a position of any identified place of potential interest relative to the current position of the vehicle.

3. The system of claim 1, wherein
the control means controls the user interface means to include an indication of the current position of the vehicle with the output; and
the control means controls the display screen to provide an indication of a customized arrangement of the desired area relative to the current position of the vehicle.

4. The system of claim 1, wherein the control means
dynamically updates a position of the desired area based on changes in the current position of the vehicle; and
dynamically identifies any places of potential interest based on the updated desired area.

5. The system of claim 1, wherein the display screen comprises a touch screen and the user interface means receives the user input based on user interaction with the touch screen.

6. The system of claim 5, wherein the control means interprets a user gesture near the touch screen as an indication of the desired area.

7. The system of claim 6, wherein the user gesture comprises at least one of:
movement of at least two fingers closer together to indicate a desire to reduce a size of the desired area;
movement of at least two fingers further apart to indicate a desire to increase a size of the desired area; and
movement of at least one finger relative to the current position of the vehicle to indicate a desire to adjust an arrangement of the desired area relative to the current position of the vehicle.

8. The system of claim 1, wherein
the user interface means receives user input indicating a desire for more information regarding a selected one of the places of potential interest; and
the control means causes the user interface means to provide additional information regarding the selected one of the places.

9. The system of claim 8, wherein the additional information comprises at least one of:
an indication of a distance to the selected one of the places from the current location of the vehicle, and
an indication of a travel time to the selected one of the places from the current location of the vehicle.

10. The system of claim 1, wherein the desired area is defined by at least one of
a geographic distance from the current position of the vehicle,
a travel distance from the current position of the vehicle, and
a travel time from the current position of the vehicle.

11. A vehicle comprising the system of claim 1.

12. A method of providing information to a driver of a vehicle through a vehicle navigation system user interface that includes at least a display screen, the method comprising:
receiving user input regarding at least one criterion of interest to the user and a desired area within which to identify a location satisfying the at least one criterion;
determining a current position and direction of travel of the vehicle;
identifying a place of potential interest as any location that satisfies the at least one criterion and is within the desired area relative to the current position of the vehicle, and
provide an output at least on the display screen, the output including an indication of the desired area and any identified place of potential interest.

13. The method of claim 12, wherein the output includes an indication of the current position of the vehicle and an indication of a position of any identified place of potential interest relative to the current position of the vehicle.

14. The method of claim 12, comprising
providing an indication of the current position of the vehicle on the display screen; and
receiving user input customizing an arrangement of the desired area relative to the current position of the vehicle.

15. The method of claim 12, comprising
dynamically updating a position of the desired area based on changes in the current position of the vehicle; and
dynamically identifying any places of potential interest based on the updated desired area.

16. The method of claim 12, wherein the display screen comprises a touch screen and receiving the user input is based on user interaction with the touch screen.

17. The method of claim 16, comprising interpreting a user gesture near the touch screen as an indication of the desired area.

18. The method of claim 17, wherein the user gesture comprises at least one of:
movement of at least two fingers closer together to indicate a desire to reduce a size of the desired area;
movement of at least two fingers further apart to indicate a desire to increase a size of the desired area; and
movement of at least one finger relative to the current position of the vehicle to indicate a desire to adjust an arrangement of the desired area relative to the current position of the vehicle.

19. The method of claim 12, comprising:
receiving user input indicating a desire for more information regarding a selected one of the places of potential interest; and
providing additional information regarding the selected one of the places on the display screen.

20. The method of claim 19, wherein the additional information comprises at least one of:
an indication of a travel distance to the selected one of the places from the current location of the vehicle, and
an indication of a travel time to the selected one of the places from the current location of the vehicle.

21. The method of claim 12, wherein the desired area is defined by at least one of
a geographic distance from the current position of the vehicle,
a travel distance from the current position of the vehicle, and
a travel time from the current position of the vehicle.

22. A vehicle comprising a controller and the display screen configured to perform the method of claim 11.
